(19) United States
(12) Patent Application Publication
(10) Pub. No.: US 2004/0235500 A1
(43) Pub. Date: Nov. 25, 2004

(54) System for providing unified cellular and wire-line service using a home cell

(76) Inventors: Kevin E. Dombkowski, Oswego, IL (US); Richard T. Emery, Aurora, IL (US); Charles A. Witschorik, Naperville, IL (US)

Correspondence Address: PATTON BOGGS, 1660 LINCOLN ST, SUITE 2050, DENVER, CO, 80264, US

(21) Appl. No.: 10/440,770

(22) Filed: May 19, 2003

(51) Int. Cl. H04Q 7/20

(52) U.S. Cl. 455/461; 455/445

(57) ABSTRACT

The home cell system provides unified cellular service and wire-line service with a single Directory Number assigned to the subscriber's telephone station set and serves to provide a connection to the cellular network via the subscriber's local wire-line (POTS line) connection to the local wire-line telephone network (PSTN). The home cell system extends the capabilities of the cellular network allowing cellular-like service to be provided at wire-line access points, including standard analog or ISDN telephones, packet phones, soft phones, smart analog phones and ISDN phones. The wireless service provider provides telecommunication features to wire-line customers, such as handset mobility and service roaming. The present home cell system presents the wire-line telephones and wireless telephones, using a wire-line access point, to the cellular network as if they were cellular telephones.

### FIELD OF THE INVENTION

This invention relates to telephone communication systems and in particular, to a system for providing unified wire-line and cellular service using a home cell that interconnects the wire-line subscriber to the cellular network.

### PROBLEM

It is a problem with existing cellular networks that many cellular subscribers are using the cellular telephones regardless of whether they are located at home, at the office or in-transit in a roaming mode. Cellular service providers have constructed their infrastructure using cell towers located along highways and in public areas to support the cellular subscribers as they traveled from location to location, rather than at fixed site locations, such as home or office. These cellular service providers have also offered unlimited call minutes and/or a significant amount of free long distance calling minutes. This has resulted in the subscribers using their cellular telephone in place of their existing wire-line telephone at home, with a commensurate increase in not only the call volume in the cellular network but also the average hold time for these calls.

The increase in the volume of cellular calls directed to or from the subscriber's home and office locations causes two problems. First, the cellular service provider must build out the cellular network infrastructure of cell towers and associated switching equipment to serve the increased call volume in residential and office locations. Secondly, there is an underutilization of the local wire-line telephone network (PSTN) since the local wire-line telephone service provider processes reduced call volumes. In some instances, the cellular service provider and the local wire-line telephone service provider are parts of the same company. Thus, the company would benefit from a system that better utilizes their existing wire-line telephone infrastructure and avoid additional investment in the cellular network infrastructure.

One existing system that partially addresses this problem is the use of dual mode handsets 305 that function both as a cordless, wire-line based telephone and a cellular telephone. FIG. 3 illustrates in block diagram form the overall architecture of existing wire-line 310 and cellular 300 networks and the implementation of inbound and outbound call connections using a dual mode telephone in this environment. The dual mode handset 305 works in conjunction with a cordless base station 306 that is located in a residence 307 and is attached to the subscriber's local wire-line (POTS line) connection to a local wire-line telephone switching system 308. When the dual mode handset 305 is within reception range of the base station 306, calls are originated and received through the connected POTS line. When the dual mode handset 305 is no longer within reception range of the base station 306, calls are originated and received with the dual mode handset 305 via the cellular network 300. One of the problems with this arrangement is that incoming calls to the subscriber are routed based on the called number. Therefore, if someone dials the subscriber's POTS number (630-222-1000), the call is routed to the cordless base station 306, even if the subscriber is out of range of the cordless base station 306 but available to receive the incoming call via the cellular network 300.

The existing Simultaneous Ring feature executing in the cellular network can be used to overcome this problem, as shown in FIG. 3. The Simultaneous Ring feature operates in response to a call directed to either the subscriber's cell phone number (630-444-1000) or the POTS line (630-222-1000) by simultaneously ringing both telephones. The subscriber can then answer using either telephone number or the dual mode handset 305 can be programmed to select the cordless base station 306 via the subscriber's local wire-line presence. The Simultaneous Ring feature therefore provides a solution to the incoming call portion of the problem but does not address the outgoing call issue of Caller ID on outgoing calls. When a subscriber initiates an outgoing call through the cordless base station 306, the Caller ID for the call is the ID of the POTS line, while a call initiated via the cellular network 300 produces a Caller ID that is the ID of the cell phone number. Thus, when a called party receives the call initiated by the subscriber, there can be confusion because of the two distinct Caller ID numbers for the same subscriber.

However, none of these systems addresses the fundamental problem that the cellular network is separate from the wire-line network and the subscriber must maintain a point of presence on both networks. Furthermore, the wire-line telephone station sets do not have access to the cellular network and cannot receive services that are presently provided therein, such as handset mobility and service roaming. Thus, there are no systems presently available that provide wire-line telephone station set number portability and the features that are presently available on the cellular network. In addition, these systems only partially address the issue of call volume migration from the wire-line network to the cellular network.

### SOLUTION

The above-described problems are solved and a technical advance achieved by the present system for providing unified wire-line and cellular service using a home cell, termed “home cell system” herein. The home cell system provides unified cellular service and wire-line service with a single Directory Number assigned to the subscriber's telephone station set and serves to provide a connection to the cellular network via the subscriber's local wire-line (POTS line) connection to the local wire-line telephone network (PSTN).

The present home cell system extends the capabilities of the cellular network allowing cellular-like service to be provided at wire-line access points, including standard analog or ISDN telephones, packet phones, soft phones, smart analog phones and ISDN phones. The wireless service provider provides telecommunication features to wire-line customers, such as handset mobility and service roaming. The customer can also use a customer-owner radio transceiver to interconnect standard wireless telephones to the cellular network through the standard PSTN analog or ISDN dial-up interfaces, data network interfaces or dedicated copper facilities. The present home cell system presents the wire-line telephones and wireless telephones, using a wire-line access point, to the cellular network as if they were cellular telephones.

Transmission of voice signals over the standard wireless air interface is inherently open for interception by unintended parties. Many commercially available wireless telephones transmit signals with little or no encryption of the signals. Even with simple encryption, off-line computing power can be used to decipher the codes. The present system allows the wireless telephone to transmit to the base station of the cellular network over any standard PSTN wire-line access point, offering wire-line security to wireless handset conversations. In addition, the telephone connected to the wire-line access point is addressed independent of the radio transceiver, base station, and switch. The HLR-VLR functionalities used to support cellular telephones are available for wire-line telephones.

As a further benefit, an implementation of a home cell in a portable arrangement allows an improvement in survivability of telecommunications service. A subscriber with a portable home cell, or a home-cell independent phone such as an IP Phone, is able to move the home cell, or the portable phone, to a new location when wireline service at the original location is not available. This relocation can be done without the assistance of the wireless service provider or the wireline service provider.

### BRIEF DESCRIPTION OF THE DRAWINGS

FIG. 1 illustrates in block diagram form the overall architecture of wire-line and cellular networks and the implementation of the present home cell system in this environment;

FIG. 2 illustrates an exemplary implementation of the present home cell system the present home cell system;

FIG. 3 illustrates in block diagram form the overall architecture of existing wire-line and cellular networks and the implementation of a dual mode telephone in this environment;

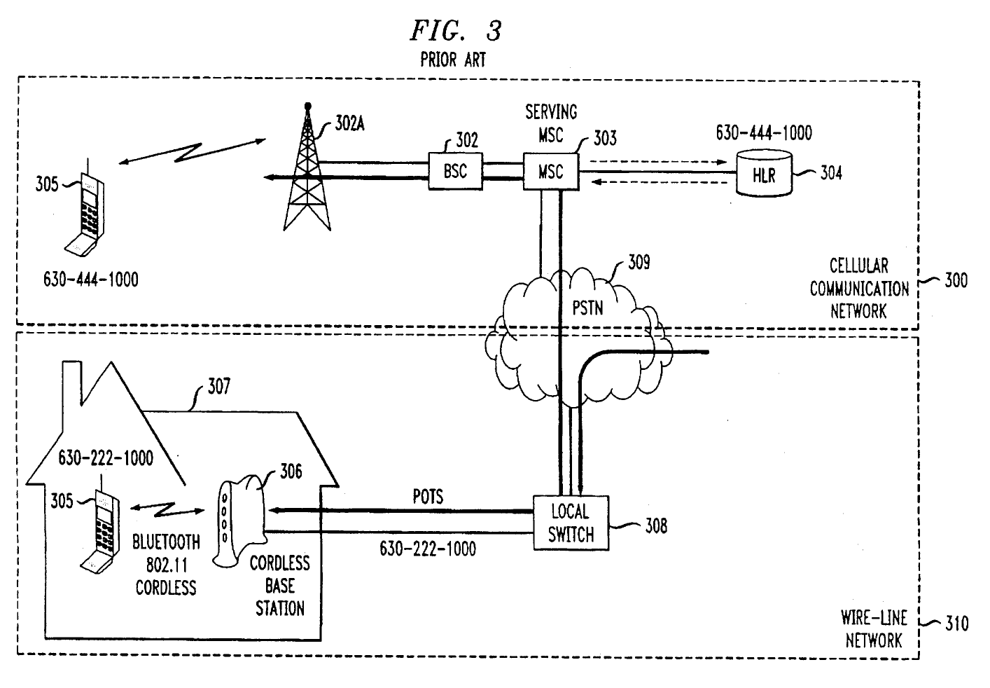

FIG. 4 illustrates in block diagram form the typical implementation of a home cell; and

FIG. 5 illustrates an example of the flow of information between a wireless telephone and a Mobile Switching Center through a Home Cell and a Dial-Up Home Cell RNS.

### DETAILED DESCRIPTION

Cellular Communication Network Philosophy

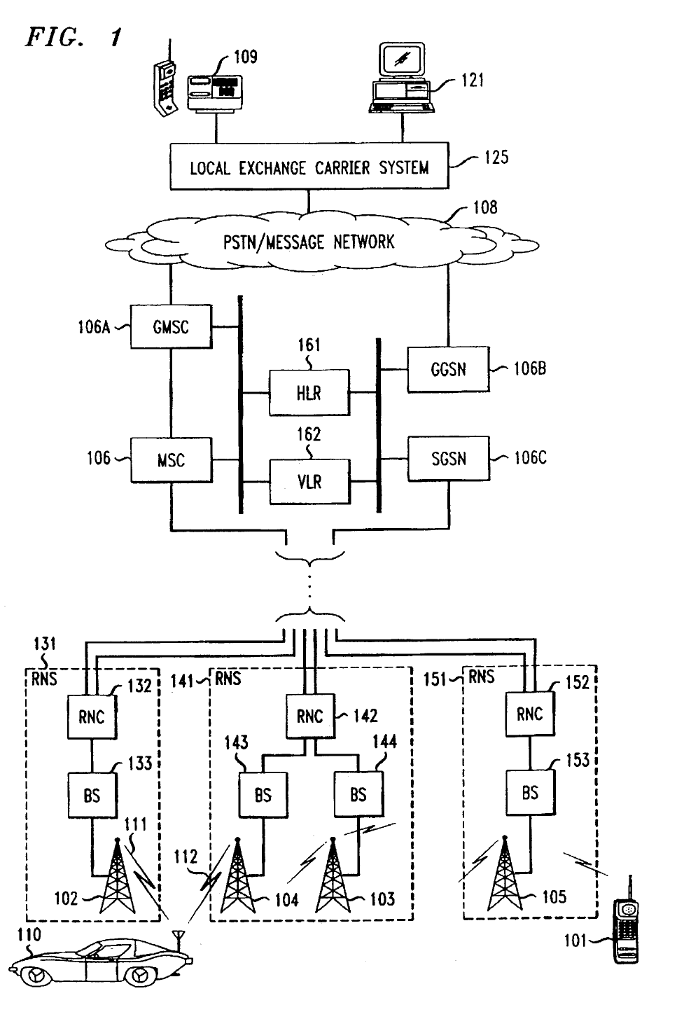

An example of a typical cellular communication network, as shown in block diagram form in FIG. 1, provides the service of connecting wireless telephone customers, each having a mobile subscriber station, to both land-based customers who are served by the Public Switched Telephone Network (PSTN) 108 as well as other wireless telephone customers. In such a network, all incoming and outgoing calls are routed through Mobile Switching Centers (MSC) 106, each of which is connected to a plurality of Radio Network Subsystems (RNS) 131-151 which communicate with mobile subscriber stations 101, 110 located in the area covered by the cell sites. The mobile subscriber stations 101, 110 are served by the Radio Network Subsystems (RNS) 131-151, each of which is located in one cell area of a larger service region. Each cell site in the service region is connected by a group of communication links to the Mobile Switching Center 106. Each cell site contains a group of radio transmitters and receivers, termed a “Base Station” (BS) herein, with each transmitter-receiver pair being connected to one communication link. Each transmitter-receiver pair operates on a pair of radio frequencies to create a communication channel: one frequency to transmit radio signals to the mobile subscriber station and the other frequency to receive radio signals from the mobile subscriber station. The Mobile Switching Center 106, in conjunction with the Home Location Register (HLR) 161 and the Visitor Location Register (VLR) 162, manages subscriber registration, subscriber authentication, and the provision of wireless services such as voice mail, call forwarding, roaming validation and so on. The Mobile Switching Center 106 is connected to a Gateway Mobile Services Switching Center (GMSC) 106A as well as to the Radio Network Controllers RNC, with the GMSC 106A serving to interconnect the Mobile Switching Center 106 with the PSTN 108. In addition, the Radio Network Controllers are connected via Serving General Packet Radio Service (GPRS) Support Node (SGSN) 106C and thence the Gateway GPRS Support Node (GGSN) 106B to a network, for example the SS7 signaling network (Message Network 108). The Radio Network Controllers 132, 142, 152 control the transmitter-receiver pairs at the Base Station and the tuning of the mobile subscriber stations to the selected radio frequencies.

In FIG. 1, the mobile subscriber station 110 is simultaneously communicating with two Base Stations 133 & 143, thus constituting a soft handoff. However, a soft handoff is not limited to a maximum of two Base Stations. When in a soft handoff, the Base Stations serving a given call must act in concert so that commands issued over RF channels 111 and 112 are consistent with each other. In order to accomplish this consistency, one of the serving Base Stations may operate as the primary Base Station with respect to the other serving Base Stations. Of course, a mobile subscriber station 110 may communicate with only a single Base Station if this is determined to be sufficient by the cellular communication network.

The control channels that are available in this system are used to setup the communication connections between the mobile subscriber stations 110 and the Base Station 133. When a call is initiated, the control channel is used to communicate between the mobile subscriber station 110 involved in the call and the local serving Base Station 133. The control messages locate and identify the mobile subscriber station 110, determine the dialed number, and identify an available voice/data communication channel consisting of a pair of radio frequencies and orthogonal coding (as an example) which is selected by the Base Station 133 for the communication connection. The radio unit in the mobile subscriber station 110 re-tunes the transmitter-receiver equipment contained therein to use these designated radio frequencies and orthogonal coding. Once the communication connection is established, the control messages are typically transmitted to adjust transmitter power and/or to change the transmission channel when required to handoff this mobile subscriber station 110 to an adjacent cell, when the subscriber moves from the present cell to one of the adjoining cells. The transmitter power of the mobile subscriber station 110 is regulated since the magnitude of the signal received at the Base Station 133 is a function of the mobile subscriber station transmitter power and the distance from the Base Station 133. Therefore, by scaling the transmitter power to correspond to the distance from the Base Station 133, the received signal magnitude at Base Station 133 can be maintained within a predetermined range of values to ensure accurate signal reception without interfering with other transmissions in the cell.

The voice communications between mobile subscriber station 110 and other subscriber stations, such as land line based subscriber station 109, is effected by routing the communications received from the mobile subscriber station 110 through the Mobile Switching Center 106 and trunks to the Public Switched Telephone Network (PSTN) 108 where the communications are routed to a Local Exchange Carrier 125 that serves land line based subscriber station 109. There are numerous Mobile Switching Centers 106 that are connected to the Public Switched Telephone Network (PSTN) 108 to thereby enable subscribers at both land line based subscriber stations and mobile subscriber stations to communicate between selected stations thereof. This architecture represents the present architecture of the wireless and wire-line communication networks.

However, there are many instances when the subscriber is located in a place where the mobile subscriber station cannot receive an incoming call, such as inside of a building, in a remote location not provisioned with cellular service, and the like. In these situations, existing cellular communication systems detect the unavailability of the mobile subscriber station and transmit a message to the calling party indicating that the mobile subscriber station in not in communication with the cellular communication system. This situation requires that the calling party must leave a voice mail message for the subscriber on their mobile subscriber station service and/or initiate another call connection to the subscriber's paging service (if the subscriber also has a pager) to leave a callback telephone number for the subscriber to use to contact the calling party.

Integration of Cellular and Wire-Line Networks

The fundamental problem with the present cellular and local wire-line network architectures is that the cellular network is separate from the wire-line network and the subscriber must maintain a point of presence on both networks. Furthermore, the wire-line telephone station sets do not have access to the cellular network and cannot receive services that are presently provided therein, such as handset mobility and service roaming. Thus, there are no systems presently available that provide wire-line telephone station set number portability and the features that are presently available on the cellular network. In addition, these systems only partially address the issue of call volume migration from the wire-line network to the cellular network.

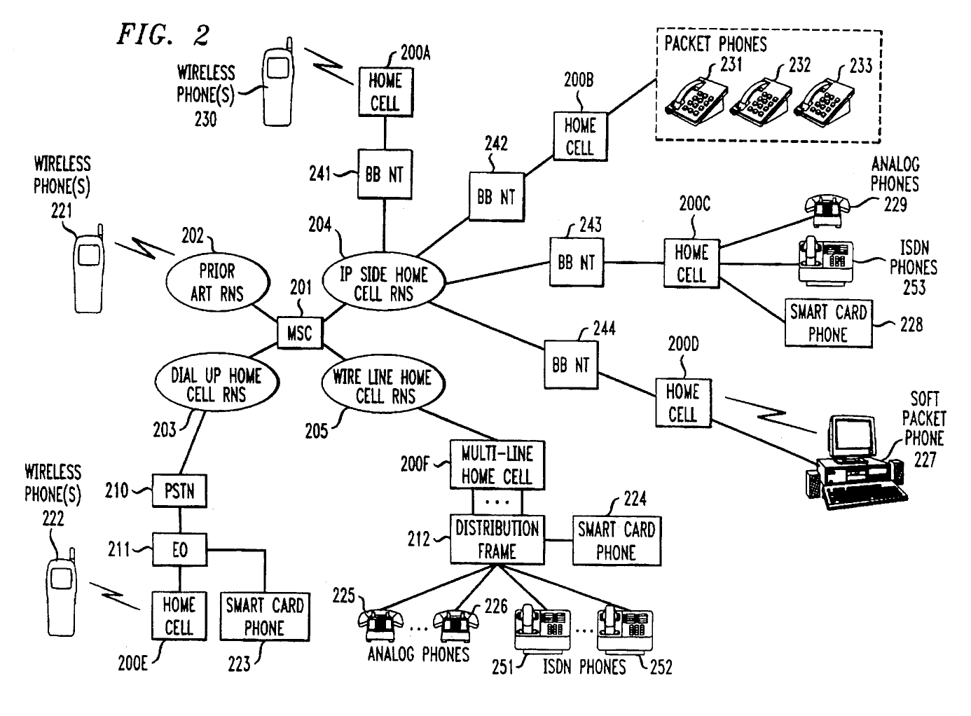

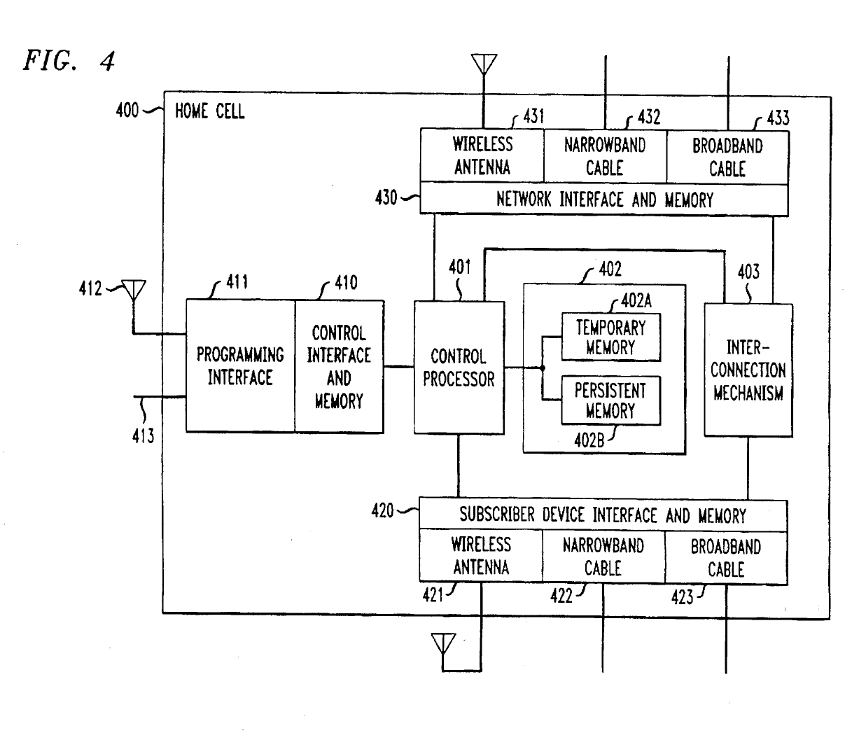

The present Home Cell system 200A-F is shown in FIG. 2 and FIG. 4 illustrates in block diagram form the typical implementation of a home cell. The Home Cell 200A-F extends the capabilities of the cellular network allowing cellular-like service to be provided at wire-line access points, including standard analog telephones, 225, 226, 229, or ISDN telephones 251, 252, 253, packet phones, 231, 232, 233, soft phones 227, and smart phones 223, 224, 228. The wireless service provider provides telecommunication features to wire-line customers, such as handset mobility and service roaming. The customer can also use a customer-owner radio transceiver to interconnect standard wireless telephones to the cellular network through the standard PSTN analog or ISDN dial-up interfaces, data network interfaces or dedicated copper facilities. The present home cell system presents the wire-line telephones and wireless telephones, using a wire-line access point, to the cellular network as if they were cellular telephones. Also shown in FIG. 2 is an existing Radio Network Subsystem 202 that serves wireless telephones, such as 221, which can be operational on Mobile Switching Center 201 in conjunction with the Home Cell Radio Network Subsystems 203-205 that serve the present Home Cell systems.

Dial-Up Home Cell RNS

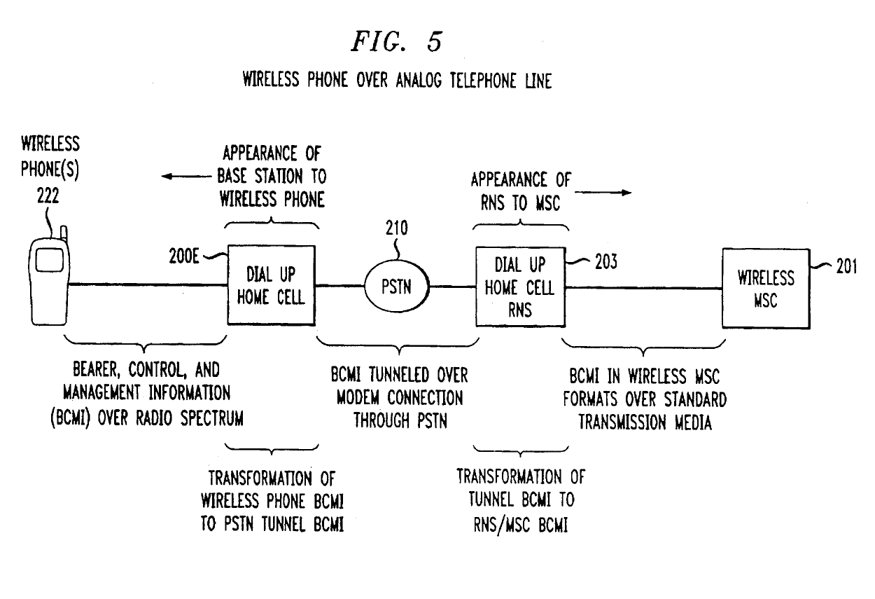

As shown in FIGS. 2 and 5, a customer premise mini-cell site, termed Home Cell 200E is used as a low power transceiver for a standard mobile telephone 222. The radio spectrum can be selected to match the spectrum of a standard cellular telephone or it can be the spectrum of a cordless telephone.

The Home Cell 200E interconnects to the Dial-Up Home Cell RNS 203 by making a call from Network Termination 432 in Home Cell 200E through the local wire-line switching system 211 and the PSTN 210. The call path that is established through the local wire-line switching system 211 and the PSTN 210 to the Dial-Up Home Cell RNS 203 constitutes a tunnel for the wireless handset signals that normally are forwarded to a standard cellular RNC over standard Ti transmission facilities. This call operation is similar to existing ISP calls and serves to interconnect the wireless telephone 222 with the Mobile Switching Center 201 via a wire-line point of access. FIG. 5 illustrates an example of the flow of information between a wireless telephone 222 and a Mobile Switching Center 201 through the Home Cell 200E and the Dial-Up Home Cell RNS 203. The Dial-Up Home Cell 200E presents the appearance of a wireless Base Station to the wireless telephone 222 and the exchange of signaling between the Dial-Up Home Cell 200E and the wireless telephone 222 includes bearer, control and management information (BCMI) which are transmitted over the radio spectrum used by the wireless telephone 222. The Dial-Up Home Cell 200E transforms the BCMI received from the wireless telephone 222 into PSTN tunnel BCMI which is transmitted via a modem connection through the PSTN 210 to the Dial-Up Home Cell RNS 203. The Dial-Up Home Cell RNS 203 converts the PSTN tunnel BCMI received from the PSTN into Radio Network Subsystem/Mobile Switching Center BCMI and presents the appearance of a Radio Network Subsystem to the Mobile Switching Center 201. The converted BCMI is then transmitted to the Mobile Switching Center 201 in a wireless Mobile Switching Center format over a standard transmission medium.

Alternatively, a Smart Card telephone 223 is used as a combined cellular telephone and Dial-Up Home Cell RNS 200E to present a standard wire-line instrument to the customer. There are no radio frequency transmissions and the Smart Card telephone 223 encodes and decodes voice signals using a standard microphone/speaker handset. The Smart Card telephone 223 is programmed with a cellular telephone number and it registers on the network by placing a telephone call to a Dial-Up Home Cell RNS 203 whenever the subscriber goes off-hook. The protocol exchange between the Smart Card telephone 223 and the Dial-Up Home Cell RNS 203 operates in the same manner as the cellular telephone.

In this application, the Dial-Up Home Cell RNS 200E receives and sends signals to a standard mobile telephone 222. The signals comprise: control information for registration, negotiation, call control, and other common functions; and voice band samples that constitute the bearer stream of the call. The Dial-Up Home Cell RNS 200E operates as a standard wireless cell site from the perspective of the wireless phone. Toward the Dial-Up Home Cell RNS 203, the Dial-Up Home Cell RNS 200E must operate as a proxy for the wireless phone in that the signals from the wireless phone must be transmitted to the Dial-Up Home Cell RNS 203 in a format that is capable of being transmitted between the Home Cell 200E and Dial-Up Home Cell RNS 203 over a narrowband connection in the PSTN/ISDN and is acceptable to the Dial-Up Home Cell RNS 203. It is anticipated that existing industry protocols between a wireless phone and an RNS are useable by the Home Cell 200E, but amendments or additions to existing protocols are also acceptable.

The Home Cell 200A-E interconnects with a Network Termination device of a network provider through, for example, a standard analog phone cable, a standard ISDN BRI cable, or other standard narrowband Network Termination 432 interface. The Network Termination 432 connects to the narrowband infrastructure of switches and links that will provide the narrowband interconnection between the Home Cell 200E and the Dial-Up Home Cell RNS 203. The connection from the narrowband infrastructure to the Dial-Up Home Cell RNS 203 can be any technology that allows the required connection, for example a multi-frequency (MF) trunk or ISDN PRI.

Wire-Line Home Cell RNS

Standard analog wire-line telephones 225, 226 and standard ISDN wire-line telephones 251, 252 are connected from the customer premises to the Distribution Frame 212 in a PSTN end office. Where the cellular service provider owns or leases the two-wire pair to the customer premises, a standard telephone switch line unit function for a wire-line access point is provided by the Wire-Line Home Cell RNS 200F. The multiple lines from the distribution frame 212 are multiplexed onto a digital transmission facility for presentation to the Wire-Line Home Cell RNS 205. The Wire-Line Home Cell RNS 205 presents the appearance of a cellular telephone to the cellular network.

IP Side Home Cell RNS Serving a Home Cell

A cellular telephone 230 and a Home Cell 200A can be connected to the IP Side Home Cell RNS 204 through a packet network BB NT (Broadband Network Termination) 241. The Home Cell 200A acts as the radio transceiver for the cellular telephone and interconnects to the IP Side Home Cell RNS 204 using existing or modified wireless packet network protocols. For devices such as wireless phones, the Home Cell 200A would operate as a standard wireless cell site as described above for the Dial-Up Home Cell RNS 203 and would provide conversion as needed between the control and bearer information of the wireless phone and the control and bearer information expected by the IP-Side Home Cell RNS 204, with appropriate transformations required by the broadband connection.

Packet telephones 231-233 can be connected to the IP Side Home Cell RNS 204 through a Home Cell 200B that converts the VolP voice encoding and protocols to the standard cellular encoding and protocols. For devices such as the Packet Phones 231-233, the Home Cell 200B would operate as an IP router to the Packet Phones 231-233 and would provide conversion as needed between the control and bearer information of the Packet Phones 231-233 and the control and bearer information expected by the IP-Side Home Cell RNS 204, with appropriate transformations required by the broadband connection via BB NT (Broadband Network Termination) 242.

Analog telephones 229 or ISDN telephones 253 and/or Smart Card telephones 228 are connected to the IP Side Home Cell RNS 204 through a Home Cell 200C that provides the necessary IAD and gateway functions. For devices such as analog phones 229, the Home Cell 200C would provide an analog line interface to the analog phone 229 and the control and bearer information expected by the IP-Side Home Cell RNS 204, with appropriate transformations required by the broadband connection via BB NT (Broadband Network Termination) 243. For devices such as Smart-Card Phones 228, the Home Cell 200C would operate as a narrowband line interface (analog or ISDN BRI) to the Smart-Card Phone 228 and would provide conversion as needed between the control and bearer information of the Smart-Card Phone 228 and the control and bearer information expected by the IP-Side Home Cell RNS 204, with appropriate transformations required by the broadband connection.

Soft IP Phones 227 are connected to the IP Side Home Cell RNS 204, wired or wireless, through a Home Cell 200D that converts the VolP voice encoding and protocols to the standard cellular encoding and protocols. For devices such as the Soft IP Phones 227, the Home Cell 200D operates as an IP router to the Soft IP Phone 227 and would provide conversion as needed between the control and bearer information of the Soft IP Phone 227 and the control and bearer information expected by the IP-Side Home Cell RNS 204, with appropriate transformations required by the broadband connection via BB NT (Broadband Network Termination) 244.

It is anticipated that existing industry protocols between a wireless phone and a cell site are useable by the Home Cell 200A-D, but amendments or additions to existing protocols are also acceptable. Information supplied by standard subscriber devices will be converted by the Home Cell 200A-D to/from the protocol formats required between the Home Cell 200A-D and the IP-Side Home Cell RNS 204, but amendments or additions to existing protocols are also acceptable.

The Home Cell 200A-D interconnects with a broadband Network Termination device, 241, 242, 243, 244, of a broadband network provider through, for example, a standard Ethernet 100 BaseT cable, an 802.11 wireless interface, or other standard broadband NT interfaces. The broadband Network Termination connects to the broadband infrastructure of switches and links that will provide the broadband interconnection between the Home Cell 200A-D and the IP-Side Home Cell RNS 204. The connection from the broadband infrastructure to the IP-Side Home Cell RNS 204 can be any technology that allows the required connection, for example an Ethernet 10OBaseT link.

Home Cell Implementation

As shown in block diagram form in FIG. 4, the Home Cell 200A-E uses both a control processor 401 and a memory 402 to coordinate the reception, transmission, manipulation and inter-connection of information to/from subscriber devices and network interfaces. Both temporary memory 402A and persistent memory 402B elements in memory 402 are anticipated, and one use for the persistent memory 402B is to store an identification tag for the Home Cell 200A-E. The identification tag can be made available to the wireless network provider through exchange of information in the call-setup protocol. Once known and associated to a call, the identification tag can be used for purposes such as billing, tracing, and quality measurements.

In the home cell, three different interface functions are expected, the Control Interface and Memory 410, the Subscriber Device Interface and Memory 420, and the Network Interface and Memory 430. These various interfaces function to interconnect the Home Cell 200A-E with the various systems and devices described above to provide the communication services to the subscribers.

Control Interface and Memory

Control Interface and Memory 410 is typically an optional element that enables the Home Cell 200A-E to be programmed with variable information. The variable information can be placed in temporary memory 402A or persistent memory 402B. As an example of variable information, a subscriber using the Home Cell 200A-E to interconnect with a wireless service provider through a Dial-Up Home Cell RNS 203 might wish to restrict calls through the Home Cell 200A-E to only those wireless phones that are owned by family members. The identification numbers of permissible wireless phones would be entered into the Home Cell 200A-E through the Programming Interface 411 using a keypad, infrared transceiver, USB port or other well-known interface technologies that could be applied to this function. The programming Interface 411 therefore may be equipped with an antenna 412 to enable the subscriber to connect to the Programming Interface 411 in a wireless manner or using a wire-line interface 413.

Subscriber Device Interface and Memory

Subscriber Device Interface and Memory 420 can be constructed from well-known technologies such as wireless transceivers 421; narrowband cables 422, broadband cables 423, processors, memory devices and the like. The use of the Subscriber Device Interface and Memory 420 is described above.

Network Interface and Memory

Network Interface and Memory 430 can be constructed from well-known technologies such as wireless transceivers 431; narrowband cables 432, broadband cables 433, processors, memory devices and the like. The use of the Network Interface and Memory 430 is described above.

An inter-connection mechanism 403 allows the passage of information between the Subscriber Device Interface 420 and the Network Interface 430. Standard technology that embodies processors, high-speed memory, and device interconnection can be used to instantiate the Interconnection Mechanism 403. The Interconnection Mechanism 403, under the control of the Control Processor 401, is the functional block that performs conversions that may be needed between the information that is expected by the subscriber devices, via the Subscriber Device Interface 420, and the Dial-Up Home Cell RNS 203 or IP-Side Home Cell RNS 204, via the Network Interface 430.

### SUMMARY

The home cell system provides unified cellular service and wire-line service with a single Directory Number assigned to the subscriber's telephone station set and serves to provide a connection to the cellular network via the subscriber's local wire-line (POTS line) connection to the local wire-line telephone network (PSTN).

What is claimed:

1. A home cell system for providing unified cellular and wire-line telephone service via a serving cellular mobile switching center, comprising:
cellular interface means for presenting at least one of wire-line telephones and wireless telephones, connected via a wire-line access point, to said serving cellular mobile switching center as if they were cellular telephones; and
call origination means, responsive to said at least one of wire-line telephones and wireless telephones originating an outgoing call, for completing said call to a destination identified by said at least one of wire-line telephones and wireless telephones via said serving cellular mobile switching center.

2. The home cell system of claim 1 further comprising:
number assignment means for assigning a single Directory Number to a cellular telephone station set for use in both said serving cellular mobile switching center and a local wire-line telephone switching system.

3. The home cell system of claim 1 further comprising:
conversion means for formatting information received from said at least one of wire-line telephones and wireless telephones into a signaling format that is expected by said serving cellular mobile switching center and information received from said serving cellular mobile switching center into a signaling format that is expected by said at least one of wire-line telephones and wireless telephones.

4. The home cell system of claim 3 further comprising:
transceiver means for providing a low power wireless transceiver for at least one standard mobile telephone.

5. The home cell system of claim 4 further comprising:
narrowband cable means for interconnecting said cellular interface means with a public switched telephone network to communicate with said serving cellular mobile switching center.

6. The home cell system of claim 4 further comprising:
broadband cable means for interconnecting said cellular interface means with a broadband network termination to communicate with said serving cellular mobile switching center through a packet network.

7. The home cell system of claim 3 further comprising:
wire-line multiplexer means connected to multiple wire-line based telephones for multiplexing signals received from said multiple wire-line based telephones onto a digital transmission facility for presentation to said cellular interface means.

8. The home cell system of claim 3 further comprising:
narrowband cable means for connecting multiple wire-line based telephones to said cellular interface means; and
broadband cable means for interconnecting said cellular interface means with a broadband network termination to communicate with said serving cellular mobile switching center through a packet network.

9. The home cell system of claim 3 further comprising:
voice encoding means for converting VolP voice encoding and protocols received from at least one packet telephone to the standard cellular encoding and protocols; and
broadband cable means for interconnecting said cellular interface means with a broadband network termination to communicate with said serving cellular mobile switching center through a packet network.

10. The home cell system of claim 3 further comprising:
Smart Card Phone means programmed with a cellular telephone number for registering on said serving cellular mobile switching center by placing a telephone call to said serving cellular mobile switching center via a wire-line interface whenever the subscriber goes off-hook.

11. A method for providing unified cellular and wire-line telephone service via a serving cellular mobile switching center, comprising:
presenting at least one of wire-line telephones and wireless telephones, connected via a wire-line access point, to said serving cellular mobile switching center as if they were cellular telephones; and
completing, in response to said at least one of wire-line telephones and wireless telephones originating an outgoing call, said call to a destination identified by said at least one of wire-line telephones and wireless telephones via said serving cellular mobile switching center.

12. The method of claim 11 further comprising:
assigning a single Directory Number to a cellular telephone station set for use in both said serving cellular mobile switching center and a local wire-line telephone switching system.

13. The method of claim 11 further comprising:
formatting information received from said at least one of wire-line telephones and wireless telephones into a signaling format that is expected by said serving cellular mobile switching center and information received from said serving cellular mobile switching center into a signaling format that is expected by said at least one of wire-line telephones and wireless telephones.

14. The method of claim 13 further comprising:
providing a low power wireless transceiver for at least one standard mobile telephone.

15. The method of claim 14 further comprising:
interconnecting said cellular interface means with a public switched telephone network via a narrowband cable to communicate with said serving cellular mobile switching center.

16. The method of claim 14 further comprising:
interconnecting said cellular interface means with a broadband network termination to communicate with said serving cellular mobile switching center through a packet network.

17. The method of claim 13 further comprising:
multiplexing, via a wire-line multiplexer connected to multiple wire-line based telephones, signals received from said multiple wire-line based telephones onto a digital transmission facility for presentation to said cellular interface means.

18. The method of claim 13 further comprising:
connecting multiple wire-line based telephones via a narrowband cable to said cellular interface means; and
interconnecting said cellular interface means with a broadband network termination to communicate with said serving cellular mobile switching center through a packet network.

19. The method of claim 13 further comprising:
converting VolP voice encoding and protocols received from at least one packet telephone to the standard cellular encoding and protocols; and
interconnecting said cellular interface means with a broadband network termination to communicate with said serving cellular mobile switching center through a packet network.

20. The method of claim 13 further comprising:
registering a Smart Card Phone programmed with a cellular telephone number on said serving cellular mobile switching center by placing a telephone call to said serving cellular mobile switching center via a wire-line interface whenever the subscriber goes off-hook.
